(19) United States
(12) Patent Application Publication
(10) Pub. No.: US 2020/0124911 A1
(43) Pub. Date: Apr. 23, 2020

(54) ARRAY COMPONENT FOR DISPLAY DEVICE

(71) Applicant: FLEXENABLE LIMITED, Cambridge (GB)

(72) Inventors: William Reeves, Cambridge (GB); James Harding, Cambridge (GB)

(73) Assignee: FLEXENABLE LIMITED, Cambridge (GB)

(21) Appl. No.: 16/655,452

(22) Filed: Oct. 17, 2019

(30) Foreign Application Priority Data
Oct. 18, 2018 (GB) 1817004.3

(51) Int. Cl. G02F 1/1335

(52) U.S. Cl. CPC G02F 1/133512; G02F 2201/123; G02F 1/133602

(57) ABSTRACT

An array component for a display device, comprising: an array of active light-emitting elements in a matrix, wherein at least some of the active light-emitting elements at a periphery of the array of active light-emitting elements have a light-emitting area that is (i) smaller than other active light-emitting elements more remote from said periphery, and (ii) different to other active light-emitting elements at said periphery of the array; wherein said active light-emitting elements are arranged in rows, and wherein (i) one or more of said active light-emitting elements in a row and at a periphery of the array have centroids aligned in a direction substantially parallel to the direction of the rows with (ii) other active light-emitting elements also in said row and more remote from said periphery.

Array components defining an array of light-emitting regions are used in pixelated display devices.

One example of such an array component is a filter array. Filter arrays are used in display devices to, for example, create a colour output from a monochromatic light source.

A conventional filter array for this purpose comprises an array of a large number of red, green and blue rectangular filters in a black matrix. Many display devices are designed to present a rectangular optical output with edges parallel to the straight-edges of the rectangular filters, but for other shapes of optical outputs such as e.g. circular outputs, there is the challenge of creating, from an array of straight-edged (e.g. rectangular) pixels, an optical output with edges that appear smooth to the viewer.

One option involves using an opaque bezel defining a window having the shape of the desired optical output, and locating the bezel over the filter array so as to at least mask the parts of peripheral colour filters that lie outside the desired optical output shape. Another option involves using the display control component (such as a liquid crystal cell component) to electrically control the intensity of light incident on peripheral filters in the array, by the kind of anti-aliasing technique used to create the enhance the viewer perception of display content including lines/edges that are not parallel to the edges of the rectangular filters of the display device.

The inventors for the present application have addressed themselves to the task of devising an alternative technique to achieving optical output edges that appear smooth to the viewer.

There is hereby provided an array component for a display device, comprising: an array of active light-emitting elements in a matrix, wherein at least some of the active light-emitting elements at a periphery of the array of active light-emitting elements have a light-emitting area that is (i) smaller than other active light-emitting elements more remote from said periphery, and (ii) different to other active light-emitting elements at said periphery of the array; wherein said active light-emitting elements are arranged in rows, and wherein (i) one or more of said active light-emitting elements in a row and at a periphery of the array have centroids aligned in a direction substantially parallel to the direction of the rows with (ii) other active light-emitting elements also in said row and more remote from said periphery.

According to one embodiment, the array of active light-emitting elements comprises an array of active filters.

According to one embodiment, the array of active filters each have a common shape, and at least some of the active filters at said periphery of the array of active filters have at least one dimension that is (i) smaller than other active filters more remote from said periphery, and (ii) different to other active filters at said periphery of the array of active filters.

According to one embodiment, the array of active filters each have a substantially rectangular shape, and at least some of the active filters have a width and/or length that is (i) smaller than other active filters more remote from said periphery, and (ii) different to other active filters at said periphery of the array.

According to one embodiment, the rows are substantially equally spaced and extend substantially parallel to an edge of the active filters, and wherein the active filters are arranged at substantially equal pitch in the rows.

According to one embodiment, the number of active filters in each row are configured to, in combination, best approximate geometrically a shape other than a rectangle; and wherein the variation in filter area of the active filters at said periphery of the array of active filters is configured to improve the perception of said shape by a viewer of the display.

According to one embodiment, the array components comprises one or more lines of black matrix material deposited onto a component comprising an array of filters in a black matrix.

According to one embodiment, said one or more lines of black matrix material comprise an annular ring of said black matrix material.

According to one embodiment, the active filters are arranged in a black matrix; and the black matrix is configured to reduce the light-emitting area of the active filters at the periphery of the array of active filters relative to active filters more remote from the periphery, and to effect a variation in light-emitting area between active filters at the periphery of the array.

According to one embodiment, at least some of the active filters at said periphery of the array of active filters comprise relatively transmissive sub-regions orderly interspersed with relatively non-transmissive sub-regions, and the proportion of relatively non-transmissive sub-regions is different to other active filters at said periphery of the array of active filters; wherein the relatively non-transmissive sub-regions and relatively transmissive sub-regions together exhibit a regular pattern over the whole area of the active filter, and wherein said regular pattern is common to both peripheral filters having a relatively high proportion of non-transmissive sub-regions and peripheral filters having a relatively low proportion of non-transmissive sub-regions.

According to one embodiment, the relatively non-transmissive sub-regions and relatively transmissive sub-regions for an active filter are geometrically centred on an array of centre points, wherein said array of centre points exhibits a regular pattern over the whole area of the respective active filter, and wherein said regular pattern is common to both peripheral filters having a relatively high proportion of non-transmissive sub-regions and peripheral filters having a relatively low proportion of non-transmissive sub-regions.

According to one embodiment, the array of active light-emitting elements comprises an array of active regions of one or more light-emitting diode materials.

There is also hereby provided a display device comprising an array component as defined above, and a light control component for controlling the intensity of light transmitted through each of the active filters.

According to one embodiment, the light control component comprises a backlight component, and an optical modulator component between the backlight component and the filter array.

According to one embodiment, the optical modulator component comprises a liquid crystal cell device.

There is also hereby provided a method of producing an array component, comprising: varying the area of light-emitting elements at a periphery of an array of active light-emitting elements to change the perception of the display output by a viewer of the display.

According to one embodiment, the method comprises producing an array component as defined above.

There is also hereby provided an array component for a display device, comprising: an array of active light-emitting elements in a matrix, wherein at least some of the active light-emitting elements at a periphery of the array of active light-emitting elements have a light-emitting area that is (i) smaller than other active light-emitting elements more remote from said periphery, and (ii) different to other active light-emitting elements at said periphery of the array.

Embodiments of the invention are described in detail hereunder, by way of example only, with reference to the accompanying drawings, in which:

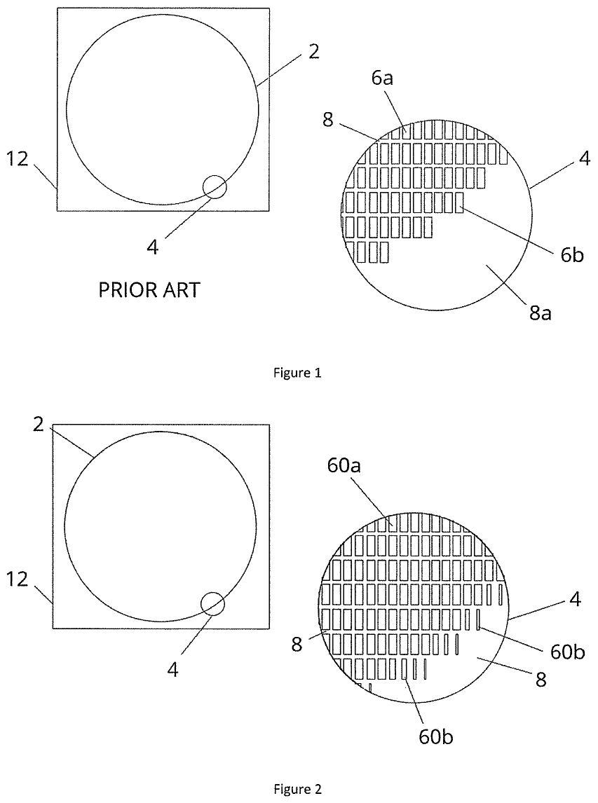

FIG. 1 illustrates a conventional array of active filters for the example of a display for presenting a circular output;

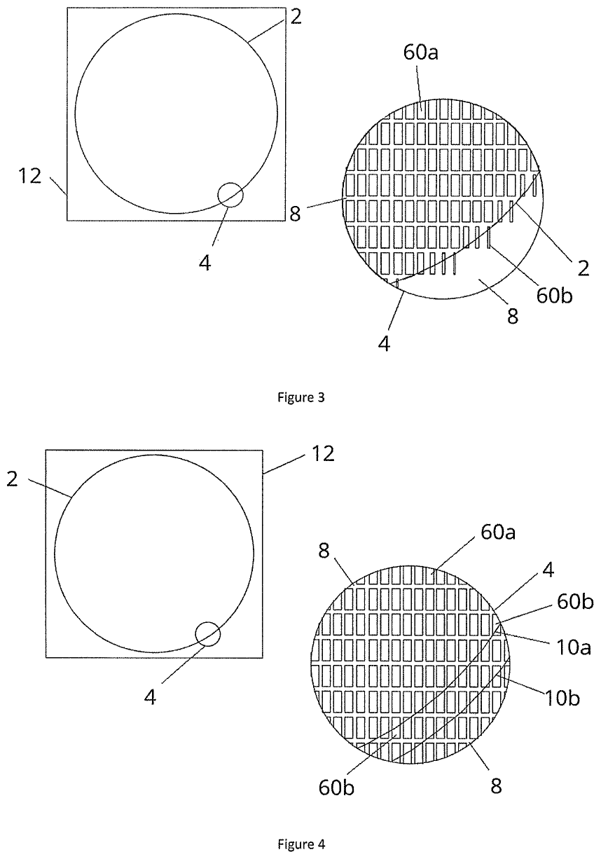

FIGS. 2 and 3 both illustrate an example of configuring active filters according to a first embodiment of the present invention for the example of a display for presenting a circular output;

FIG. 4 illustrates an example of configuring active filters according to a second embodiment of the present invention, also for the example of a display for presenting a circular output;

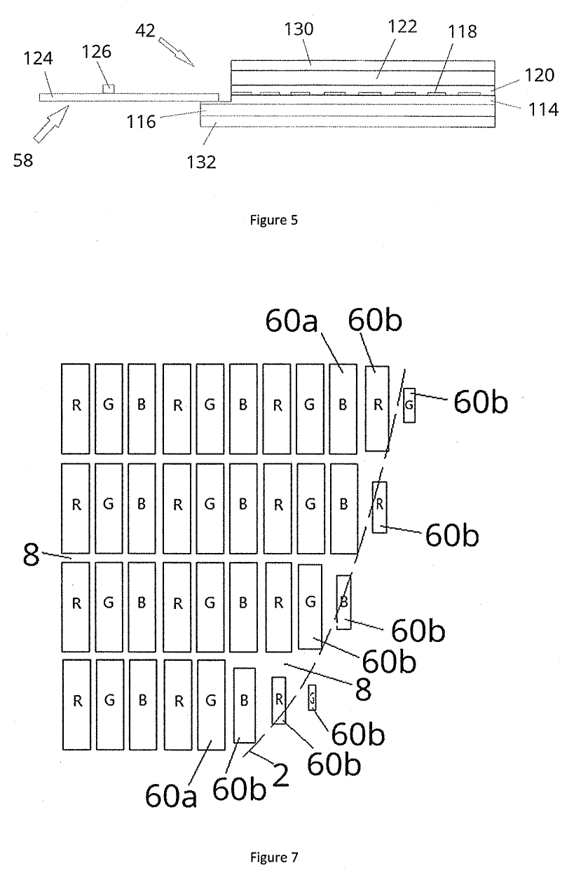

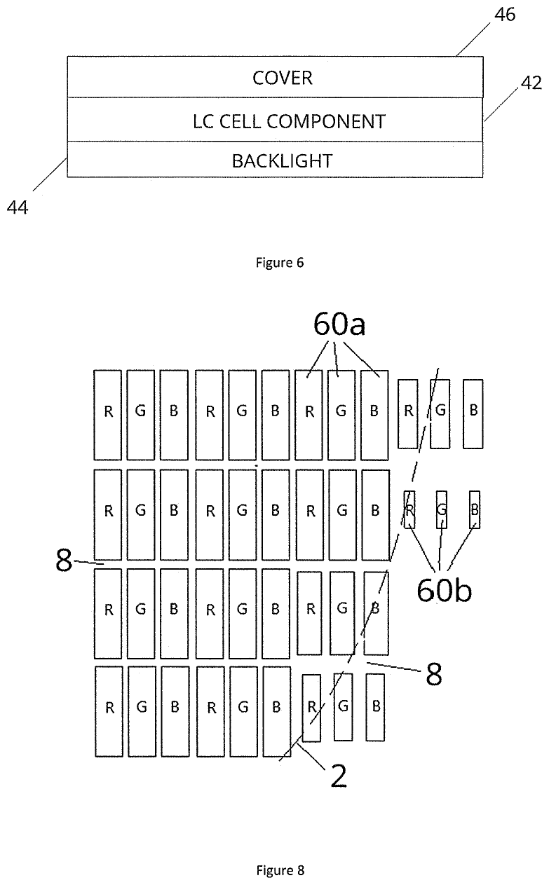

FIGS. 5 and 6 illustrate an example of one technique for incorporating a filter array according to the first or second embodiment of the invention in a display device;

FIG. 7 illustrates another example of configuring active filters according to an embodiment of the present invention, also for the example of a display for presenting an output with a curved edge;

FIG. 8 illustrates yet another example of configuring active filters according to an embodiment of the present invention, also for the example of a display for presenting an output with a curved edge;

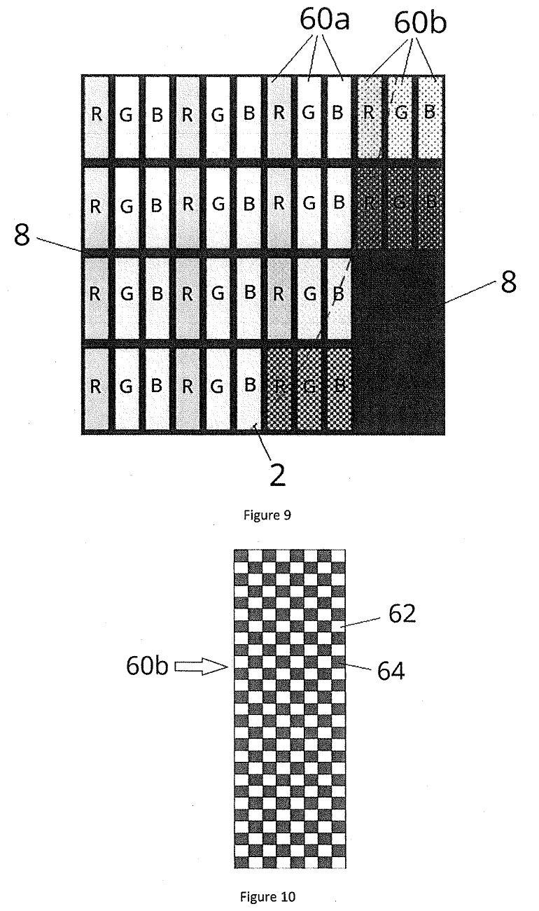

FIGS. 9 and 10 illustrate yet another example of configuring active filters according to an embodiment of the present invention, also for the example of a display for presenting a output with a curved edge; and

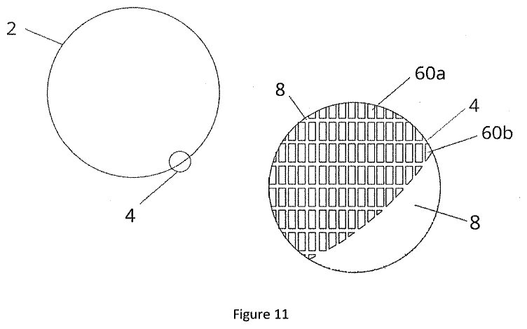

FIG. 11 illustrates yet another example of configuring active filters according to an embodiment of the present invention, also for the example of a display for presenting an output with a curved edge.

The embodiments described below are for the example of a filter array, but the technique is equally applicable to other types of array components, such as e.g. an array of regions of one or more light-emitting diode materials in a matrix.

The embodiments described below are for the example of a display designed to present a circular optical output to the viewer, but the same techniques are equally applicable to displays designed to present other shapes of optical outputs to the viewer.

The embodiments described below are for the example of a filter array comprising red, blue and green filters, but the techniques are equally applicable to e.g. filter arrays comprising a different combination of colour filters (such as an array including red, green, blue and white (all colour) filters), and filter arrays comprising filters other than colour filters.

The term “active filter” refers to a filter that contributes to the display output. The filter array may additionally include redundant filters that do not contribute to the display output (e.g. because no light is ever to be transmitted there through and/or because they are masked by another component, e.g. bezel, separate to the filter array).

FIG. 1 illustrates a conventional filter array 12 for a display designed to present a circular output 2 to the viewer. A part 4 of the filter array around a part of the edge 2 of the desired output (i.e. as desired to be perceived by the viewer) is shown in detail, which part is representative of the remainder of the edge of the desired circular output 2. The filter array 12 comprises a regularly repeating pattern of red, green and blue filters 6 in a black (opaque, non-transmitting) matrix 8. The filters 6 all have the same substantially rectangular shape and the same size. The filters 6 are arranged in a plurality of equally spaced parallel rows with the same pitch (distance between centroids of adjacent filters) within the row. The rows of filters are aligned with each other such that the centroids of the filters 6 are aligned in a direction perpendicular to the rows. The number or filters 6 in each row is configured such that the combination of pixels best approximates geometrically the desired circular output 2 to be presented to the viewer.

FIGS. 2 and 3 illustrate a variation (of the filter array of FIG. 1) according to a first embodiment of the present invention. In this example, the filter array 12 is generally the same as that of FIG. 1: the filter array 12 is designed to present a circular optical output to the viewer; the filter array 12 comprises a regularly repeating pattern of red, green and blue filters 60a, 60b in a black (opaque, non-transmitting) matrix 8; and the filters 60a, 60b are arranged in a plurality of equally spaced parallel rows at a uniform pitch (distance between centroids (geometric centres)s of adjacent filters) within the row. The rows of filters are aligned with each other such that the centroids of the filters 60a, 60b are aligned in a (column) direction perpendicular to the rows. Each active filter has a centroid aligned with those of all other active filters in the same row and same column (including active filters at the periphery of the array); the centroids of all active filters in the same row are aligned in a direction parallel to the direction of the row, and the centroids of all active filters in the same column are aligned in a direction parallel to the direction of the column.

Again, a part 4 of the filter array around a part of the edge 2 of the desired output is shown in detail, which part is representative of the remainder of the edge 2 of the desired circular output.

The filters 60a at the interior of the array of active filters all have the same substantially rectangular shape and the same size. In the example of FIGS. 2 and 3, the active filters 60b at the periphery of the array of active filters also have a rectangular shape with at least one common dimension; in the example of FIGS. 2 and 3, the peripheral active filters have the same length (dimension in a direction perpendicular to the row direction) as all other active filters 60a, 60b in the filter array. The peripheral active filters 60b are arranged at the same intra-row pitch (distance between the centroids of adjacent filters in the same row) as all other active filters in the filter array. Additionally, as mentioned above, the centroids of the peripheral active filters in a row are aligned with the centroids of all other active filters in the same row. However, the peripheral active filters 60b have at least one dimension (e.g. filter width and/or filter length) that is different to active filters 60a at the interior of the array of active filters, and varies between active filters 60b at the periphery of the array of active filters. In the examples of FIGS. 2 and 3, the peripheral active filters have the same length (dimension in a direction perpendicular to the row direction) as active filters 60a at the interior of the array of active filters, but have a width (dimension in a direction parallel to the row direction) that is different to the active filters 60a at the interior of the array of active filters, and varies between active filters 60b at the periphery of the array of active filters. FIGS. 2 and 3 are the same, except that FIG. 3 additionally shows the outline 2 of the desired circular output (i.e. the outline of how the output is desired to be perceived by the viewer). In this example, the width of each active filter 60b at the periphery of the array of active filters is related to the ratio of (a) the portion of the centre length (i.e. length at the width midpoint) of the filter 60b within outline 2 to (b) the portion of the centre length of the filter 60b outside outline 2. For example, the width of each active filter 60b may have a linear, or squared, or exponential, or Gaussian relationship to the ratio of (a) the portion of the centre length (i.e. length at the width midpoint) of the filter 60b within outline 2 to (b) the portion of the centre length of the filter 60b outside outline 2.

According to one variation, a reduction in filter width is applied to not only the active filter at the periphery but also to one or more active filters adjacent to the periphery filter 60b in the same row as the periphery filter 60b. For example, the filter width could decrease gradually towards the periphery over a contiguous series of two or more filters including the periphery filter 60b.

As mentioned above, in the example of FIGS. 2 and 3, a variation in light-emitting area at least for the peripheral active filters is achieved by varying one dimension of the filter (e.g. width or length) at least for the peripheral active filters. FIG. 7 illustrates an alternative example in which a variation in light-emitting area is achieved by varying both the filter width and the filter length for the peripheral active filters. Another alternative example of achieving a variation in light-emitting area is shown in FIG. 9 and discussed in more detail further below.

In the example described above, the filters are grouped into groups of three: one green filter, one red filter and one blue filter. According to one variation of the technique described above, a reduction in filter width is applied to all three filters of the group of filters including a periphery filter 60b. For example, the reduction in filter width may be the same for all three RGB filters in the group, as illustrated in FIG. 8.

FIGS. 9 and 10 illustrate yet another alternative example, in which a variation in light-emitting area is achieved by a dithering technique involving varying the proportions in which filter material (62 in FIG. 10 showing detail for one active filter 60b at the periphery of the array) and black matrix material 64 are orderly interspersed over a common area (e.g. an area substantially equal to the area of the active filters 60a at the interior of the array). In this example, each filter of each set of RGM active filters at the periphery of the array includes an ordered pattern of common-shaped areas (e.g. square areas) 64 of black matrix material within the area of the filter. The ordered pattern is regular and repeating over the whole area of the filter. The ordered pattern is the same for each filter (both the number of common-shaped areas 64 of black matrix material within the filter area and the location of the centroids of the common-shaped areas 64 within the filter area is the same for each filter), but the size of the common-shaped areas 64 of black matrix material is varied between sets of RGB filters to achieve a variation in light-emitting area between sets of RGB filters at the periphery of the array. According to one variation of the example of FIG. 9, the proportion of black matrix material within the filter area (and therefore also the light-emitting area within the filter area) is also varied across the three filters of each active set of RGB filters at the periphery of the array.

FIG. 4 illustrates another variation (of the filter array of FIG. 1) according to a second embodiment of the present invention. In this example, the filter array is again generally the same as that of FIG. 1: the filter array 12 is again designed to present a circular optical output to the viewer; the filter array 12 comprises a regularly repeating pattern of red, green and blue filters 60a, 60b in a black (opaque, non-transmitting) matrix 8; and the filters 60a, 60b are arranged in a plurality of equally spaced parallel rows at a uniform pitch (distance between centroids of adjacent filters) within the row. The rows of filters are aligned with each other such that the centroids of the filters 60a, 60b are also aligned in columns in a (column) direction perpendicular to the rows.

Again, a part 4 of the filter array around a part of the edge of the desired circular output 2 (i.e. the output as desired to be perceived by the viewer) is shown in detail, which part is representative of the remainder of the edge of the desired circular output 2.

In the example of FIG. 4, a standard rectangular array of filters 60a, 60b is customised by depositing an annular ring of black matrix material (e.g. by ink-jet printing) on the standard array of filters 12. The annular ring thereby lies in a plane above the black matrix around the active filters (interior and periphery filters). The annular ring has a width sufficient to at least cover all remaining parts of those filters 60b that lie partially inwards of the inner edge 10a of the annular ring. Those filters wholly or partially outside the outer edge 10b of the annular ring are redundant filters and do not ever contribute to the optical output of the display device.

Since the annular ring 10a, 10b of black matrix material is part of the filter array, parallax is less of an issue than if masking were to be done away from the filter array, such as part of a front cover component.

According to one variation illustrated in FIG. 11, the black matrix 8 itself is customised to achieve the same effect as depositing an annular ring of black matrix material over a standard array of filters 12. The black matrix 8 itself is configured to vary the light-emitting area of active filters at the periphery of the array both relative to active filters 60a at the interior of the array and relative to other active filters 60b at the periphery of the array. The customised black matrix 8 thus achieves the same effect as the annular ring mentioned above but with black matrix material in the same plane as the black matrix material around the active filters 60a at the interior of the array.

FIGS. 5 and 6 illustrate one example for incorporating a filter array 12 according to the first or second embodiment of the invention in a display device.

In the example of FIG. 5, the filter array is an integral part of a liquid crystal (LC) optical modulator component 42. A stack 114 of conductor, semiconductor and insulator layers is formed in situ on a plastics support film 116. The stack 114 defines an array of pixel electrodes 118, and electrical circuitry for independently controlling each pixel electrode via conductors outside the array of pixel electrodes 118. The stack 114 may, for example, define an active matrix array of thin-film transistors, including: an array of gate conductors each providing the gate electrode for a respective row of TFTs, and extending to outside the array of pixel electrodes; and an array of source conductors each providing the source electrode for a respective column of TFTs, and extending to outside the array of pixel electrodes. Each pixel electrode is associated with a respective TFT, and each TFT is associated with a unique combination of gate and source conductors, whereby each pixel electrode can be addressed independently of all other pixels.

A substantially uniform thickness of liquid crystal material 120 is contained between the array of pixel electrodes 118 and a plastics film counter component 122 comprising the filter array 12 according to the first or second embodiment of the invention. A COF unit 124 is bonded to a portion of the support film 116 outside the array of pixel electrodes 118 to create a conductive connection between (i) an array of conductors (e.g. source and gate addressing conductors) defined by the stack 114 in a region outside the array of pixel electrodes 118 and (ii) a corresponding array of conductors of the COF unit, which are connected to the terminals of one or more driver chips 126 forming part of the COF unit.

The optical modulator component 42 is combined with a backlight component 44 and one or more other components such as a front cover component 46.

According to another variation, the annular ring 10a, 10b described above is combined with a gradual reduction in filter width towards the periphery over a contiguous series of pixels in the same row as a periphery filter, in order to achieve a fade with better colour-balance, and a smoother edged cut-off.

As mentioned above, the technique of varying the area of active light-emitting regions at a periphery of active light-emitting regions is also applicable to other kinds of array components, such as array components comprising an array of active regions of one or more light-emitting diode materials in a black matrix. Such an array component may be produced by patterning a continuous layer of black matrix material in situ over an array of pixel electrodes (of a control component) to remove black matrix material in the region of each pixel electrode of an array of active pixel electrodes, and forming light-emitting diodes in the regions of the pixel electrodes by processing including providing one or more light-emitting diodes materials in the regions of the pixel electrodes. The area over which black matrix material is removed in the region of a pixel electrode affects the area over which a light-emitting diode is formed in the region of the pixel electrode, and thus affects the intensity of the optical output of the light-emitting diode for a given electrical input signal. According to an example embodiment of the present invention, the area over which black matrix material is removed is less in the regions of at least active pixel electrodes at the periphery of the array of active pixel electrodes than in the regions of active pixel electrodes more remote from the periphery. The principles discussed above for the filter array also apply to this example embodiment.

In addition to any modifications explicitly mentioned above, it will be evident to a person skilled in the art that various other modifications of the described embodiment may be made within the scope of the invention.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

1. An array component for a display device, comprising: an array of active light-emitting elements in a matrix, wherein at least some of the active light-emitting elements at a periphery of the array of active light-emitting elements have a light-emitting area that is (i) smaller than other active light-emitting elements more remote from said periphery, and (ii) different to other active light-emitting elements at said periphery of the array; wherein said active light-emitting elements are arranged in rows, and wherein (i) one or more of said active light-emitting elements in a row and at a periphery of the array have centroids aligned in a direction substantially parallel to the direction of the rows with (ii) other active light-emitting elements also in said row and more remote from said periphery.

2. The array component according to claim 1, wherein the array of active light-emitting elements comprises an array of active filters.

3. The array component according to claim 2, wherein the array of active filters each have a common shape, and at least some of the active filters at said periphery of the array of active filters have at least one dimension that is (i) smaller than other active filters more remote from said periphery, and (ii) different to other active filters at said periphery of the array of active filters.

4. The array component according to claim 3, wherein the array of active filters each have a substantially rectangular shape, and at least some of the active filters have a width and/or length that is (i) smaller than other active filters more remote from said periphery, and (ii) different to other active filters at said periphery of the array.

5. The array component according to claim 3, wherein the rows are substantially equally spaced and extend substantially parallel to an edge of the active filters, and wherein the active filters are arranged at substantially equal pitch in the rows.

6. The array component according to claim 4: wherein the number of active filters in each row are configured to, in combination, best approximate geometrically a shape other than a rectangle; and wherein the variation in filter area of the active filters at said periphery of the array of active filters is configured to improve the perception of said shape by a viewer of the display.

7. The array component according to claim 2, comprising one or more lines of black matrix material deposited onto a component comprising an array of filters in a black matrix.

8. The array component according to claim 7, wherein said one or more lines of black matrix material comprise an annular ring of said black matrix material.

9. The array component according to claim 2, wherein: the active filters are arranged in a black matrix; and the black matrix is configured to reduce the light-emitting area of the active filters at the periphery of the array of active filters relative to active filters more remote from the periphery, and to effect a variation in light-emitting area between active filters at the periphery of the array.

10. The array component according to claim 2, wherein at least some of the active filters at said periphery of the array of active filters comprise relatively transmissive sub-regions orderly interspersed with relatively non-transmissive sub-regions, and the proportion of relatively non-transmissive sub-regions is different to other active filters at said periphery of the array of active filters; wherein the relatively non-transmissive sub-regions and relatively transmissive sub-regions together exhibit a regular pattern over the whole area of the active filter, and wherein said regular pattern is common to both peripheral filters having a relatively high proportion of non-transmissive sub-regions and peripheral filters having a relatively low proportion of non-transmissive sub-regions.

11. The array component according to claim 10, wherein the relatively non-transmissive sub-regions and relatively transmissive sub-regions for an active filter are geometrically centred on an array of centre points, wherein said array of centre points exhibits a regular pattern over the whole area of the respective active filter, and wherein said regular pattern is common to both peripheral filters having a relatively high proportion of non-transmissive sub-regions and peripheral filters having a relatively low proportion of non-transmissive sub-regions.

12. The array component according to claim 1, wherein the array of active light-emitting elements comprises an array of active regions of one or more light-emitting diode materials.

13. A display device comprising an array component according to claim 2, and a light control component for controlling the intensity of light transmitted through each of the active filters.

14. The display device according to claim 13, wherein the light control component comprises a backlight component, and an optical modulator component between the backlight component and the filter array.

15. The display device according to claim 14, wherein the optical modulator component comprises a liquid crystal cell device.

16. An array component for a display device, comprising: an array of active light-emitting elements in a matrix, wherein at least some of the active light-emitting elements at a periphery of the array of active light-emitting elements have a light-emitting area that is (i) smaller than other active light-emitting elements more remote from said periphery, and (ii) different to other active light-emitting elements at said periphery of the array.
